(19) United States
(12) Patent Application Publication
(10) Pub. No.: US 2025/0201471 A1
(43) Pub. Date: Jun. 19, 2025

(54) MAGNETIC DEVICE

(71) Applicant: Shenzhen Sunlord Automotive Electronics Co., Ltd., Shenzhen (CN)

(72) Inventors: Jingxin Huang, Shenzhen (CN); Jiang Li, Shenzhen (CN); Jinnan Liu, Shenzhen (CN); Yaoguang Li, Shenzhen (CN); Jianfeng Liu, Shenzhen (CN); Zhiying He, Shenzhen (CN); Yinchuan Li, Shenzhen (CN); Jijie Zhao, Shenzhen (CN); Yingxin Wang, Shenzhen (CN); Guiqiang Zhu, Shenzhen (CN); Andong Liu, Shenzhen (CN); Shaohui Zheng, Shenzhen (CN)

(73) Assignee: Shenzhen Sunlord Automotive Electronics Co., Ltd., Shenzhen (CN)

(21) Appl. No.: 18/673,449

(22) Filed: May 24, 2024

(30) Foreign Application Priority Data
Dec. 14, 2023 (CN) 202311723201X
Dec. 14, 2023 (CN) 2023117226767
Dec. 14, 2023 (CN) 2023117227882
Dec. 14, 2023 (CN) 2023117227952
Apr. 18, 2024 (CN) 2024208149333

(51) Int. Cl. H01F 27/30; H01F 27/24; H01F 27/29

(52) U.S. Cl. CPC H01F 27/306; H01F 27/24; H01F 27/292

(57) ABSTRACT

A magnetic device provided includes a magnetic core, a middle column, windings, metal terminals, a magnetic cover, and adhesive layers. Side boards are connected at two ends of the middle column, a functional groove is defined in the side board. Both ends of each winding provides with winding terminals. The metal terminals are disposed on one side of each side boards. Each two of the metal terminals at different side boards are opposite to each other, the winding terminal is electrically connected to a welding part of each metal terminal through the functional groove. The magnetic cover is connected to the magnetic core and together with the magnetic core to form a closed magnetic circuit. Each adhesive layer is arranged between each two of the side boards, the metal terminals and the magnetic cover; and the magnetic cover and the metal terminals are bonded and fixed on the magnetic core.

This non-provisional patent application claims priority under 35 U. S. C. § 119 from Chinese Patent Application No. 2023117226767, 2023117227882, 202311723201X, and 2023117227952 all filed on Dec. 14, 2023; and Chinese Patent Application No. 2024208149333 filed on Apr. 18, 2024, the entire content of which is incorporated herein by reference.

### TECHNICAL FIELD

The application relates to magnetic device technologies, in particular to a magnetic device.

### BACKGROUND

Magnetic devices are widely used in an automotive field, the magnetic devices can deal with power filtering and power conversion and other related problems, it is useful to reduce the common mode noise in power circuits, that can ensure the normal work of electronic equipment in the car. The magnetic devices also can be applied to automotive cables and signal lines to effectively reduce electromagnetic interference that helps automotive systems meet electromagnetic compatibility standards. In actual operating conditions of the automobiles, mechanical vibrations, uncertain mechanical impacts, working temperature in the range of −50° C. to +150° C., various humidity conditions, salt spray conditions and altitude, etc., bring great challenges to the reliability of magnetic device in related technologies. In order to better meet requirements of the magnetic device in the automotive environment, it is necessary to provide a magnetic device with an excellent reliability.

### SUMMARY

Accordingly, there is necessary to provides a magnetic device to improve a reliability of magnetic device.

To achieve the above purposes, technical solutions adopted are as follows:

A magnetic device includes a magnetic core, a middle column, windings, metal terminals, a magnetic cover, and adhesive layers. Side boards are connected at two ends of the middle column, a functional groove is defined in the side board. The windings wind on the middle column according to a preset rules, and both ends of each winding provides with winding terminals. The metal terminals are disposed on one side of each side boards away from the column at a certain interval. Each two of the metal terminals at different side boards are respectively opposite to each other, the winding terminal is electrically connected to a welding part of each metal terminal through the functional groove. The magnetic cover is connected to the magnetic core and together with the magnetic core to form a closed magnetic circuit. Each adhesive layer is arranged between each two of the side boards, the metal terminals and the magnetic cover; and the magnetic cover and the metal terminals are bonded and fixed on the magnetic core

Further, the side board defines first matching grooves, and the metal terminals are respectively matched in the first matching grooves through corresponding adhesive layers, and a groove depth of each first matching groove is larger than a thickness of one corresponding metal terminal of a first multiple.

Further, the functional grooves are located on one sides of the each side board away from the magnetic cover, and between two adjacent metal terminals.

Further, one side of the metal terminal is provided with a connecting leg toward the side board, and both sides of the side board away from the function groove define second matching grooves communicated with the first matching grooves correspondingly, and the connecting leg is fixed in the second matching groove through a corresponding adhesive layer.

Further, ach metal terminal is connected with a first outer leg, and the first outer leg is snapped on one side of the side board away from the magnetic cover and protruding out of an outer surface of the side board

Further, 0.1B≤A≤B; or, B<A≤B+1.5 mm, A indicates a shortest distance between one side of the welding part close to the first outer leg and one side of the first outer leg away from the welding part; B indicates a width of the first outer leg.

Further, first auxiliary grooves are defined on the both sides of the side board, second auxiliary grooves are defines on sides of the magnetic cover corresponding to the first auxiliary grooves, and the first auxiliary grooves are communicate with the second auxiliary grooves respectively, and the first auxiliary grooves and the second auxiliary grooves are filled with the adhesive layers correspondingly.

Further, a third auxiliary groove is defined on one side of the side board close to the magnetic cover, and the third auxiliary groove is located between two adjacent metal terminals, and a fourth auxiliary groove is defines on the magnetic cover and corresponding to the third auxiliary groove, and the third auxiliary groove is communicated with the fourth auxiliary groove, the third auxiliary groove and the fourth auxiliary groove are filled with the adhesive layer respectively.

Further, the functional grooves are defined on the both sides of the side board, and fifth auxiliary grooves are defined at one end of the magnetic cover and corresponding to the metal terminals, and the side board defines sixth auxiliary grooves, the first matching groove and the fifth auxiliary groove are communicated through the sixth auxiliary groove, the fifth auxiliary groove and the sixth auxiliary groove are filled with the adhesive layer respectively.

Further, third matching grooves are defined in the side board and located at the first matching grooves respectively, and a bending leg integrally extends from each metal terminal and each bending leg is inserted into one third matching groove and is fixed inside the third matching groove through the corresponding adhesive layer.

Further, each metal terminal defines a matching through hole, and the bending leg extend into the matching through hole or maintained at a certain distance with the matching through hole, and the adhesive layer extends to the matching through hole.

Further, each metal terminal defines a matching through hole, and the bending leg extend into the matching through hole or maintained at a certain distance with the matching through hole, and the adhesive layer extends to the matching through hole.

Further, each functional groove arranged on one side of the side board and the one side of the side board has a functional inclined plane at each functional groove, one side of the metal terminal is connected with a functional leg, the welding part is located on the functional leg correspondingly, and the functional leg is stuck on the functional inclined plane.

Further, one side of the side board away from the magnetic cover is connected with functional platforms, and each functional platform protrudes from the functional inclined plane, and each metal terminal is connected with a second outer leg, and the second outer leg is clamped on the functional platform and protruding from the outer surface of the side board.

Further, the second outer legs are symmetrically arranged on the side boards at a certain distance from each other, and the second outer legs on the same side board are located between the functional inclined planes arranged symmetrically.

Further, one side of each metal terminal is connected with a functional leg located in the first matching groove, and the welding part is located on the functional leg, and the welding part and the winding terminal are corresponding to the functional groove.

Further, the functional grooves and the first matching grooves are communicated, and there is a chamfer portion at a connection between one functional groove and on corresponding first matching groove.

Further, one side of the metal terminal is provided with a functional leg, and the welding part is located on the functional leg, and the functional leg and the metal terminal are provided with a waist, and the two ends of the waist are connected with the functional leg and the metal terminal respectively, a width of the waist is a width of the functional leg of a second multiple.

Further, one side of the metal terminal is provided with a functional leg, and one end of the functional leg is provided with a chamfer portion, and the welding part is located on the chamfer portion, and there is a setting angle between an extension direction of the winding terminal after electrically connected via the functional groove and one side of the chamfer portion towards the functional groove.

Further, the magnetic device of claim 1, wherein the middle column and the side board are integrally connected to form an I shape or a drum shape, and a part of the side board protruding from the middle column forms a leg wall, and a height of the leg wall relative to the middle column is greater than a height of the windings relative to the middle column

As described above, in the magnetic device, the magnetic cover is connected on the magnetic core and together to forms a closed magnetic circuit, the windings are arranged around the middle column of the magnetic core according to the preset rules, and the metal terminals are relatively arranged and connected at a certain interval on the side board away from the middle column, each side board defines functional grooves. The winding terminals are electrically connected to the welding parts of the metal terminals through the functional grooves, and the adhesive layers are arranged between each two of the side board, the metal terminal and the magnetic cover, and the magnetic cover, and the metal terminal to be bonded to the magnetic core respectively. That is, the structural reliability of magnetic device is improved and the comprehensive performance of magnetic device is optimized based on the above characteristics.

### BRIEF DESCRIPTION OF THE DRAWINGS

In order to explain the technical scheme in the embodiments of the application more clearly, the supplementary drawings needed in the description of the embodiments are briefly introduced in the following. Obviously, the supplementary drawings described below are only some embodiments of the Application, and other supplementary drawings can be obtained according to the supplementary drawings without creative labor for the technicians in the field.

FIG. 1 is a schematic diagram of a magnetic device in accordance with a first embodiment;

FIG. 2 is a schematic diagram of a second magnetic device in accordance with a second embodiment;

FIG. 3 is a schematic diagram of a third magnetic device in accordance with a third embodiment;

FIG. 4 is a schematic diagram of a fourth magnetic device in accordance with a fourth embodiment;

FIG. 5 is a schematic diagram of a fifth magnetic device in accordance with a fifth embodiment

FIG. 6 is a schematic diagram of a sixth magnetic device in accordance with a sixth embodiment;

FIG. 7 is a schematic diagram of a seventh magnetic device in accordance with a seventh embodiment;

FIG. 8 is a schematic diagram of an eighth magnetic device in accordance with an eighth embodiment;

FIG. 9 is a schematic diagram of a ninth magnetic device in accordance with a ninth embodiment;

FIG. 10 is a schematic diagram of a tenth magnetic device in accordance with a ninth embodiment.

Labels in the Figures: 1. magnetic core; 11. middle column; 12. side board; 13. first matching groove; 14. second matching groove; 15. third matching groove; 16. functional platform; 17. second outer leg; 2. winding; 21. winding terminal; 3. metal terminal; 31. welding department; 32. first outer legs; 33. connecting leg; 34. bend pin; 35. through hole; 36. functional leg; 37. waist; 38. chamfer portion; 4. magnetic cover; 5. adhesive layer; 50. main colloidal part; 51. first adhesive part; 52. second adhesive part; 53. third adhesive part; 54. fourth adhesive part; 6. functional groove; 71. first auxiliary groove; 72. second auxiliary groove; 73. third auxiliary groove; 74. fourth auxiliary groove; 75. fifth auxiliary groove; 76. sixth auxiliary groove; 77. seventh auxiliary groove; 8. leg wall.

### DETAILED DESCRIPTION OF THE EMBODIMENTS

An exemplary embodiment is described in detail herein, and an example of which is shown in the accompanying figure. When the following description refers to supplementary drawings, the same number in different supplementary drawings indicates the same or similar elements unless otherwise indicated. The embodiments described in the following exemplary embodiments do not represent all embodiments that are consistent with this application. Rather, they are only examples of devices and methods that are consistent with some aspects of this application as detailed in the attached claims.

It is important to note that in this article, the term “including”, “including” or any other variation thereof is intended to cover non-exclusive inclusion such that a process, method, article or apparatus comprising a set of elements includes not only those elements but also other elements not explicitly listed, or it includes elements inherent to such a process, method, article or device. In the absence of more restrictions, the statement “including a. . . . The limited element does not preclude the existence of another identical element in the process, method, article or device including the element. In addition, the parts, features and elements with the same name in different embodiments of this application may have the same meaning or different meaning. Its specific meaning shall be determined by its interpretation in the particular embodiment or further combined with the context in the particular embodiment.

It is understood that the specific embodiments described herein are intended only to explain this Application and are not intended to qualify it.

In the subsequent description, the use of suffixes such as “module”, “part” or “unit” to denote an element is only for the benefit of the description of this application and has no specific meaning in itself. Therefore, “module,” “part,” or “unit” can be used interchangeably.

In the description of this application, it is necessary to explain that the orientation or position relationship indicated by the terms “up”, “down”, “left”, “right”, “inside” and “outside” are based on the orientation or position relationship shown in the attached drawings and are only for the convenience of describing this application and simplifying the description. Rather than indicating or implying that the device or element in question must be of a particular orientation, constructed and operated in a particular orientation, and therefore cannot be construed as a limitation of this application. In addition, the terms “first”, “second”, “third” are used only for descriptive purposes and cannot be understood to indicate or imply relative importance.

The technical scheme shown in this application will be explained in detail by specific embodiments in the following. It should be noted that the following order of description of embodiments does not qualify the order of precedence of embodiments.

As described above in the background, the magnetic device are widely used in automotive systems. However, in the actual operation conditions of the automobiles, accompanied by mechanical vibration, uncertain mechanical impact, working temperature in the range of −50° C. to +150° C., various humidity conditions, salt spray conditions and altitude, magnetic device in related technologies do not have the reliability applicable to them. Thus, it cannot guarantee its good working life. the application discloses a magnetic device based on this.

### Embodiment 1

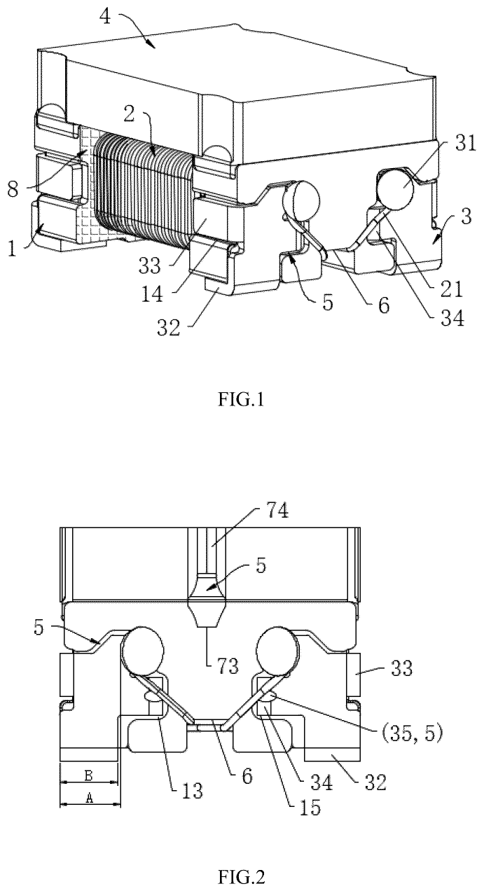

Referring to FIG. 1, a magnetic device of a first embodiment includes a magnetic core 1, windings 2, metal terminals 3, a magnetic cover 4, and adhesive layers 5.

In detail, the magnetic core 1 includes a middle column 11, and side boards 12 connected at two ends of the middle column 11, the windings 2 are arranged around the middle column 11 according to pre-set rules, and each end of the windings 2 provides a winding terminal 21. The metal terminals 3 are disposed on one side of each side board 12 far away from the middle column 11 at a certain interval, and each two of the metal terminals at different side boards are respectively opposite to each other, the winding terminal. The magnetic cover 4 is connected to the magnetic core 1 and forms a closed magnetic circuit with the magnetic core 1. The adhesive layers 5 are arranged between each two of the side boards 12, the metal terminals 3, and magnetic cover 4, that the magnetic cover 4 and the metal terminals 3 are bonded to the magnetic core 1 respectively.

In the specific implementation process, there are functional groove 6 defined in the side boards 12, and each winding terminal 21 is connected to one corresponding metal terminal 3 on one side of the corresponding side board 12 far away from the middle column 11. In detail, the winding terminal 21 is passed over the corresponding side board 12 from the middle column 11, and then connected to metal terminal 3 guiding by the functional groove 6, so as to ensures that there are enough space between joints between the winding terminals 21 and welding parts the winding 2, so as to improve a structural reliability of the magnetic device and optimize a comprehensive performance of the magnetic device.

Further, each the side board 12 defines first matching grooves 13, and the metal terminals 3 are matched in the first matching grooves 13 through the corresponding adhesive layers 5, so as to make the metal terminals 3 and the magnetic core 1 firmly connected as a whole, in which contour shapes of the metal terminals 3 can be matched with groove shapes of the first matching grooves 13 correspondingly, so as to facilitate a fixed connection of the metal terminals 3 and the magnetic core 1.

A groove depth of each first matching groove 13 is larger or equal to a thickness of the corresponding one metal terminal 3 of a first multiple, that is, each metal terminals 3 can be protected by a groove wall surrounding one corresponding first matching grooves 13, or define connection relationships of the metal terminals 3 through shapes of the groove walls of the first matching groove 13 so that the metal terminals 3 and the first matching groove 13 cooperate firmly and neatly.

In this embodiment, a value of the first multiple may be rang from 0.1 to 1.2, that is, the groove depth of each first matching groove 3 is lager or equal to (0.1 to 1.2) times thickness of the corresponding metal terminal 3.

Considering that the metal terminals 3 are bonded on the magnetic core 1 by the adhesive layers 5, that is, when the groove depth of each first matching groove 13 is equal to 1.2 times the thickness of the corresponding metal terminal 3, an outer surfaces of the metal terminals 3 are flush with an outer surface of the side board 12, that is, the thickness of one corresponding adhesive layer 5 between the first matching groove 13 and metal terminal 3 is 0.2 times the thickness of the metal terminal 3.

When the value of the first multiple is larger than or equal to 0.1 but smaller than 1.2, the metal terminals 3 protrude out of the first matching groove 13.

For other examples, the value of the first multiple can also be a fixed value, such as 0.25, 0.4, 0.6, 0.8 or 1.0 times.

Each of metal terminals 3 are connected with a first outer leg 32, the first outer leg 32 is locked on one side of the side board 12 away from the magnetic cover 4 and protrudes from the outer surface of the side board 12, that is, the connection relationships between the metal terminals 3 and the magnetic core 1 are stabilized through the first outer legs 32, and the metal terminals 32 protrude from the side board 12 are also convenient for connecting the magnetic device to external object.

In this embodiment, the first outer legs 32 can be symmetrically disposed on one side board 12, and the first outer legs 32 are located on the same plane and can be parallel to the one side board 12, so as to installed the magnetic device easily.

The first outer legs 32 and the metal terminals 3 are formed integrally respectively, and each outer leg perpendicularly extend from one edge of the corresponding metal terminal 3, so that the metal terminals 3 can be conveniently and reliably assembled on the magnetic core 1.

It should be noted that each metal terminal 3 is integrally connected with the welding part 31, and the functional groove 6 guide the corresponding winding terminal 21 to fix and electrically connected with the welding part 31 on the side of the side board 12 away from the middle column 11 after passing over the side board 12 from the middle column 11. The fixing method for the winding terminal 21 and the welding part 31, can be laser welding fixation or hot pressing welding fixation.

An end of the welding part 31 away from the metal terminals 3 can also be a sphere, so as to ensure that the winding terminal 21 is wrapped on the welding part 31 conveniently and quickly, and the sphere shape can also prevent the scratching of the winding terminal 21 due to smooth surface of the sphere, that is it can ensure that the winding terminal 21 can act on the welding part 31 evenly via the end of the welding part 31,.

Of course, the end of the welding part 31 in this embodiment is not limited to to a sphere and the welding part 31 can also be other shapes to facilitate the fixed connection of the winding terminal 21, which will not be described here.

In this embodiment, the winding terminals 21 should be drawn from both ends of the winding 2. Taking two stacked windings 2 as an example, the same end of two windings 2 can correspondingly lead to two winding terminals 21 of different layers. The two winding terminals 21 are wound around the welding parts 31 correspondingly after passing through the functional grooves 6. That is facilitate to weld and fix the windings 2, and construct a coil loop of the windings 2.

It is understandable that the metal terminals 3 on each side board 12 are relatively disposed and maintained at a certain interval to avoid wrong contact between adjacent metal terminals 3, and the windings 2 are wound according to the preset rules, the preset rules can be to choose a plurality of the windings 2 with the same winding directions, or alternate, to reduce leakage inductance; or setting requirements of a layer quantity, a winding density, and wire material used in winding 2, etc.

In the specific implementation process, there are the adhesive layers 5 for fixed connection between the side board 12 and the metal terminals 3. In the same way, there are adhesive layers 5 between the side board 12 and the magnetic cover 4, and between the metal terminals 3 and the magnetic cover 4, so that it is easy to fix the magnetic cover 4 and the metal terminals 3 on the magnetic core 1 through the adhesive layers 5. As a result it ensures the stability of the overall structure of the magnetic device.

Further, the middle column 11 and the side board 12 are integrally connected to present an I shape or a drum shape. A part of the side board 12 protruding from the middle column 11 forms a leg wall 8. A height of the leg wall 8 relative to the middle column 11 is greater than a height of the windings 2 relative to the middle column 11, so as to make the windings 2 wind, and construct a closed magnetic circuit between the magnetic cover 4 and the magnetic core 1 facilitatly.

In this embodiment, the first outer legs 32 can be extended to be parallel with the leg wall 8, and the magnetic device of the embodiment can prevent the magnetic field loss and reduce the magnetic leakage of the magnetic core 1 based on the leg wall 8, so as to reduce the influence on surrounding electromagnetic sensitive components in the actual working process, and improve the comprehensive performance of the magnetic device.

The magnetic core 1 and the magnetic cover 4 are made of magnetic materials, and the magnetic materials can selected one or more from ferrite materials, magnetic metal alloy materials, ferrosilicon alloy materials or soft magnetic materials, to meet the working requirements of magnetic device.

In this embodiment, the middle column 11 can be a rectangular shape so that windings 2 can be stacked more easily, that is, more winding space is provided. The edge and corner in rectangular shapes can also be used to adjust the magnetic field distribution of the magnetic device, which is helpful to optimize the performance of the inductor components and easier to process and manufacture in the production process.

In this embodiment, the windings 2 can be made of enamelled copper wire material, and winding 2 is composed of at least one enamelled wire. It is understandable that copper is an excellent conductive material with low resistance characteristics. Using enamelled copper wire to make the windings 2 can reduce the resistance of the inductor element and improve the current transmission efficiency, and the copper has good thermal conductivity. It can effectively conduct heat from the windings 2, and avoid the decline or damage of the inductance performance caused by excessive temperature. On the other hand, the enamelled copper wire is usually able to withstand higher temperatures and is suitable for the windings 2 in high temperature environments, which is very important for magnetic device that need to work under high temperature conditions, and the enamelled copper wire has high corrosion resistance. As a result, it can resist the erosion of some chemical substances, thus extending the service life of magnetic device.

### Embodiment 2

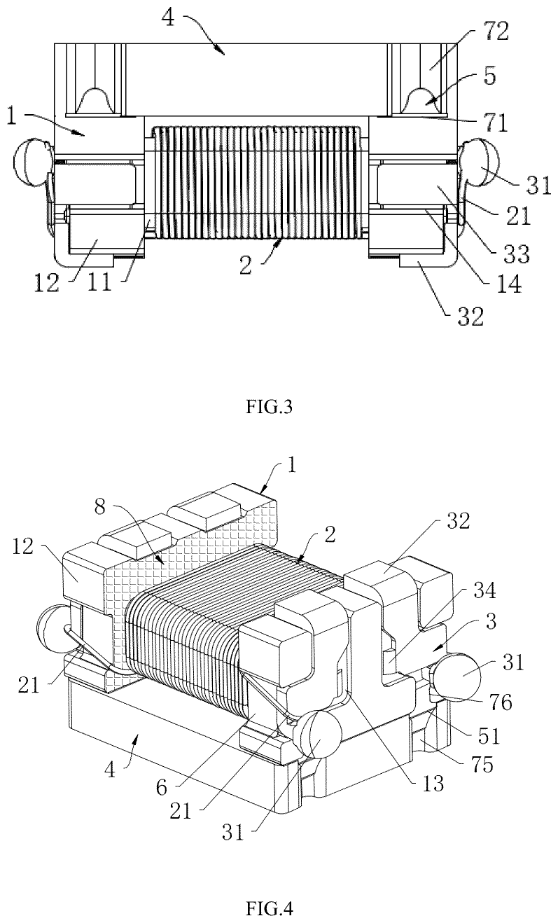

Referring to FIGS. 1, 2 and 3, this embodiment uses the same label as the embodiment 1. This embodiment is different from the first embodiment is that: the functional grooves 6 are located on the side of the side board 12 deviating from the magnetic cover 4 and between the adjacent metal terminals 3.

In the specific implementation process, each the functional groove 6 is located between the adjacent metal terminal 3, and the winding terminal 21 is electrically connected with the welding part 31 of the metal terminal 3 through the functional groove 6, and due to position limiting function of the functional groove 6, the winding terminals 21 of each windings 2 can be connected with the metal terminals 3 through the functional groove 6 together at the same end. Thus, the structure processing of magnetic core 1 can be optimized, and the performance-price ratio of the magnetic device can be improved.

Further, one side of each metal terminal 3 is provided with a connecting leg 33 toward the side board 12, and two sides of the side board 12 defines second matching grooves 14 communicated with the first matching groove 13, and the connecting leg 33 is fixed in the second matching groove 14 by the corresponding adhesive layer 5, that is the first matching grooves 13 and the second matching grooves 14 ensure stably connection between the metal terminals 3 and the side boards 12, so that the metal terminals 3 and the magnetic core 1 are firmly connected as a whole, so as to improve the structural reliability of the magnetic device.

The side boards 2 also define third matching grooves 15, and each third matching groove 15 is located in one of the first matching groove 13, and the metal terminals 3 is integrally connected with a bending leg 34. The bending leg 34 is inserted into the third matching groove 15 and fixed in the third matching groove 15 by the adhesive layer 5, so as to improve the structural reliability of the magnetic device.

Further, a matching through hole 35 is defined on each metal terminal 3, which is located at the bending leg 34, and the corresponding adhesive layer 5 is extended to the matching through hole 35, so as to enhance the connection between the bending leg 34 and the metal terminal 3 in the third matching groove 1, and fix metal terminals 3 to the magnetic core and the structural reliability of the whole of the magnetic device through the matching through hole 35 and the adhesive layer 5 at the bending leg 34.

In the specific implementation process, in order to strengthen the connection relationship between the side boards 12 and the magnetic cover 4, the side boards 12 also defines first auxiliary grooves 71, and one side of the magnetic cover 4 corresponding to the first auxiliary grooves 71 defines second auxiliary grooves 72, the first auxiliary grooves 71 and the second auxiliary grooves 72 are communicated with each other. The first auxiliary groove 71 and the second auxiliary groove 72 are filled with the corresponding adhesive layers 5, so as to make the magnetic cover 4 and the magnetic core 1 firmly connected as a whole by the adhesive layers 5, and improve the structural reliability of the magnetic device.

Further, a third auxiliary groove 73 is defined on one side of the side board 12 near the magnetic cover 4, and the third auxiliary groove 73 is located between the two adjacent metal terminals 3, and a fourth auxiliary groove 74 is defined on the magnetic cover 4 and corresponding to the third auxiliary groove 73, and the third auxiliary groove 73 is communicated with the fourth auxiliary groove 74. The the third auxiliary groove 73 and the fourth auxiliary groove 74 are filled with the corresponding adhesive layers 5, that is, the stable connection between the magnetic cover 4 and the magnetic core 1 is further strengthened by the adhesive layers 5.

It should be noted that the third auxiliary groove 73 can be corresponding to the functional groove 6, that is, a matching position of the magnetic cover 4 and the magnetic core 1 can be calibrated through the third auxiliary groove 73 to prevent a accidental displacement or offset of the magnetic cover 4, so as to ensure the integrity of the structure of the whole magnetic device.

Each section contour of groove walls of the first auxiliary groove 71, the second auxiliary groove 72, the third auxiliary groove 73 and the fourth auxiliary groove 74 maybe in a shaped of a circular arc, a zigzag, a triangle or a wedge to ensure the adhesive layers 5 fully to contact and bond to the groove walls of the first auxiliary groove 71, the second auxiliary groove 72, the third auxiliary groove 73, and the fourth auxiliary groove 7, so as to ensure the overall connection stability of the magnetic device.

Referring to FIG. 2, in the specific implementation process, setting a minimum distance between the side of each welding part 31 close to the corresponding first outer legs 32 and the side of the corresponding first outer legs 32 e far away from welding part 31 as A, a width of the corresponding first outer legs 32 is B, and 0.1B≤A≤B that it will prevent the welding part 31 from completely shading the corresponding first outer legs 32 on a vertical projection of the magnetic cover 4 toward the corresponding first outer legs 32. It is understood that the first outer legs 32 need to be electrically connected to objects outside via tin material. For example, due to 0.1B≤A≤B, when it is necessary to observe whether ⅓-½ of a height of the outer surface of the first outer legs 32 on the side of the first matching groove 13 all occurs tin climbing it is convenient and quick to obtain the tin climbing state of the first outer legs 32.

On the other hand, B<A≤B+1.5 mm, from the vertical projection of the magnetic cover 4 toward the first outer legs 32, each welding parts 31 and the corresponding first outer legs 32 can maintain an obvious gap or distance, and tin climbing state of the first outer legs 32 will be obtained.

Of course, A can also be a fixed multiple, that is, setting the shortest distance between the side of each welding part 31 close to the corresponding first outer legs 32 and the side of the corresponding first outer legs 32 e far away from welding part 31 as A, a width of the corresponding first outer legs 32 is B, then A=0.25B, A=0.5B or A=0.8B.

When A=0.25B, it can be seen that on the vertical projection from the magnetic cover 4 to the first outer legs 32, the welding part 31 covers ¾ of the first outer legs 32. Similarly, when A=0.5B, the welding part 31 covers ½ of the first outer legs 32. When A=B, the welding part 31 covers the first outer legs 32. The welding part 31 adheres to the side of the first outer legs 32 and completely exposes the first outer legs 32.

That is, in this embodiment, the magnetic cover 4 is connected to the magnetic core 1 and forms a closed magnetic circuit with the magnetic core 1, the windings 2 are wound around the middle column 11 of the magnetic core 1 according to the preset rules, and the metal terminals 3 are arranged on the side boards 12 which located at the two ends of the middle column 11, at the certain interval. The side boards 12 deviate from the magnetic cover 4 and define functional grooves 6 located between each two adjacent metal terminals 3. The winding terminals 21 at both ends of each layer of winding 2 are electrically connected with the welding part 31 of metal terminal 3 through the functional grooves 6, and the metal terminals 3 is bonded to the side board 12 and fixed in the first matching groove 13. The metal terminals 3 are matched with the side boards 12 through the connecting leg 33, the bending legs 34 and the marching through holes 35, and under the bonding strength of the adhesive layers 5, the structural reliability of the magnetic device is improved overall, so as to improve the comprehensive performance of the magnetic device.

### Embodiment 3

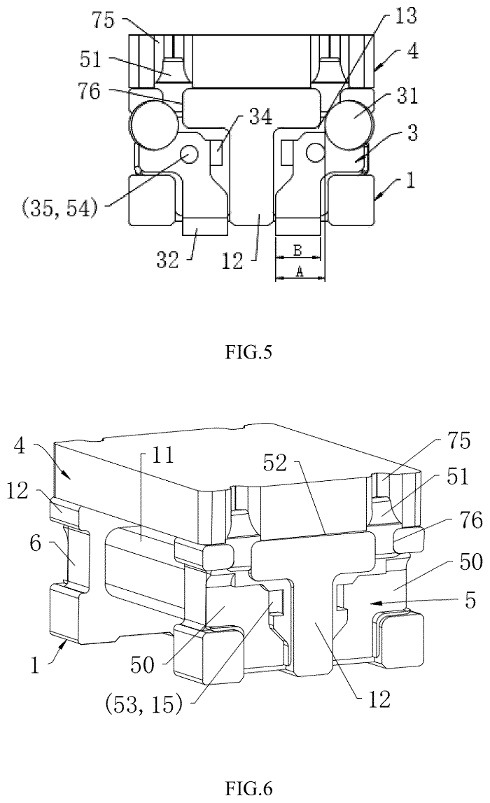

Referring to FIGS. 4, 5 and 6, this embodiment and the above embodiments adopt the same labels, the magnetic core 1, the windings 2, the metal terminals 3, the magnetic cover 4 and the adhesive layers 5 are the same as that of the above embodiments, that is, the magnetic core 1 includes the middle column 11 and the side boards 12 connected at the two ends of the middle column 11. The windings 2 are wound around the central column 11 according to the preset rules, and both ends of each windings 2 are equipped with the winding terminals 21, the metal terminals 3 are correspondingly arranged and connected to the sides of side boards 12 away from the middle column 11, the magnetic cover 4 is connected to the magnetic core 1 and forms a closed magnetic circuit with the magnetic core 1. The adhesive layers 5 are arranged between each two of the side boards 12, the metal terminals 3 and the magnetic cover 4, and the magnetic cover 4 and the metal terminals 3 are bonded to the magnetic core 1 respectively; each side board 12 defines the functional grooves 6, the winding terminals 21 are electrically connected with the welding parts 31 of the metal terminals 3 through the functional grooves 6, each side board 12 also defines the first matching grooves 13, and the metal terminals 3 are fixed in the first matching grooves 13 through the corresponding adhesive layer 5.

A difference between this embodiment and the above embodiment is that, the functional grooves 6 are arranged on both sides of the side board 12.

In the specific implementation process, the functional grooves 6 are arranged on both sides of the side board 12, and a groove depth of the functional groove 6 is greater than the wire diameter of the winding terminals 21 to protect the winding terminal 21 located on the side of the side board 12. Under the guidance of the functional groove 6, the winding terminals 21 of the winding 2 at the same end can be connected with the welding parts 31 of the metal terminals 3 through the functional grooves 6 on both sides of the side board 12 so as to optimize the structure processing of the magnetic core 1 and improve the performance-price ratio of the magnetic device.

Further, a fifth auxiliary grooves 75 are defined at one end of the magnetic cover 4 corresponding to the metal terminals 3, sixth auxiliary grooves 76 are defined in the side board 12, the first matching grooves 13 and the fifth auxiliary grooves 75 are communicate with each other through the sixth auxiliary grooves 76, and the first matching grooves 13, the fifth auxiliary grooves 75 and the sixth auxiliary grooves 76 are filled with the adhesive layers 5. In order to ensure the magnetic cover 4 to steadily fix to the magnetic core 1, the magnetic core 1, the metal terminals 3 and the magnetic cover 4 are bonded together by the adhesive layers 5 as a whole, so as to improve the structural reliability of the magnetic device.

Half or all of the fifth auxiliary groove 75 or the sixth auxiliary groove 76 are filled with the adhesive layer 5, to ensure that the magnetic cover 4 and the magnetic core 1 to fix together. In order to make the adhesive layers 5 better extend to the fifth auxiliary groove s75, an end of the fifth auxiliary grooves 75 towards the side board 12 is in a shape of a bell mouth, that is, a size of the fifth auxiliary groove 75 can gradually decreases from the side board 12 to the magnetic cover 4.

It should be noted that the position of the fifth auxiliary grooves 75 on the magnetic cover 4 can correspond to the metal terminals 3, that is, the symmetrical fifth auxiliary grooves 75 can also calibrate the matching position of the magnetic cover 4 and the magnetic core 1 to prevent the accidental displacement or offset of the magnetic cover 4, so as to ensure the overall structure of the magnetic device to stay organized.

It can be understood that in this example, the shortest distance between the side of each welding part 31 of metal terminal 3 close to the corresponding first outer legs 32 and the side of the corresponding first outer legs 32 away from the welding part 31 of the metal terminal 3 is A, and the width of the corresponding first outer leg 32 is B, 0.1B≤A≤B or B<A≤B+1.5 mm, that the tin climbing state of the first outer legs 32 is mastered, which will not be described here.

A third matching grooves 15 are defined in side board 12 and located in the first matching grooves 13, and each metal terminals 3 are integrally connected with a bending leg 34. Each bending leg 34 is inserted into one corresponding third matching groove 15 and fixed in the corresponding third matching groove 15 by the adhesive layer 5. The matching through holes 35 are provided on the metal terminals 3, and the matching through hole 35 is kept at a certain distance from the bending leg 34. The connection relationship between each bending leg 34 and the corresponding third matching groove 15 is enhanced by the matching the through hole 35 and the adhesive layer 5, and then the metal terminals 3 is fixed on the magnetic core 1 to ensure the stability of the overall structure of the magnetic device.

### Embodiment 4

Referring to FIGS. 4, 5 and 6, this embodiment adopts the same label as embodiment 3. A difference between this embodiment and the above embodiments is that, the adhesive layers 5 of this embodiment may include a main colloid part 50, a first adhesive part 51, a second adhesive part 52, a third adhesive part 53 and a fourth adhesive part 54.

In the specific implementation process, the first adhesive part 51 is connected with the main colloid part 50, and the main colloid part 50 is connected between the side board 12 and the metal terminals 3. The first adhesive part 51 is extended to each fifth auxiliary groove 75 and each sixth auxiliary groove 76, that is, the main colloid part 50 is bonded the side board 12 and the metal terminals 3 respectively based on the structural of adhesive layer 5. With the cooperation of the fifth auxiliary groove 75 and the sixth auxiliary groove 76, the first adhesive part 51 ensures the fixed connection between the magnetic cover 4 and the magnetic core 1, and makes the magnetic core 1, the metal terminals 3, and the magnetic cover 4 firmly connected as a whole by the adhesive layers 5, so as to improve the structural reliability of the magnetic device.

Further, half or all of each fifth auxiliary groove 75 and each sixth auxiliary groove 76 are filled with the first adhesive part 51 extending to the fifth auxiliary groove 75 and the sixth auxiliary groove 76, to ensure the magnetic cover 4 and the magnetic core 1 to be fixed connected together. The end of the fifth auxiliary groove 75 toward the side board 12 is a bell mouth shape, so that the first adhesive part 51 can be better extended to the fifth auxiliary groove 75, that is, the size of the fifth auxiliary groove 75 can be gradually decreases from the end of the corresponding side board 12 to the end of the magnetic cover 4.

In order to further improve the stable connection relationship between the magnetic cover 4 and the magnetic core 1, the adhesive layers 5 can include a second adhesive part 52 connected with the main colloid part 50, and the second adhesive part 52 is connected between each side board 12 and the magnetic cover 4. In detail, each side board 12 and the magnetic cover 4 can maintain regular gaps face to face. The second adhesive part 52 can be extended from the main colloidal part 50 and fully filled in the gaps to ensure the fixed connection between each side board 12 and the magnetic cover 4.

On the other hand, the side of the side board 12 facing the magnetic cover 4, and/or the side of the side board 4 facing the side board 12 can also be provided with an embedded groove body, and then the second adhesive part 52 can be placed through the embedded groove body to ensure the fixed connection between the side board 12 and the magnetic cover 4.

In this embodiment, the third adhesive part 53 is connected with the main colloid part 50, and the third adhesive part 53 is filled between the third matching groove 15 and the bending leg 34, so as to ensure the bending leg 34 to fix in the third matching groove 15 stably through the third adhesive part 53, thus greatly improve the stable connection relationship between the metal terminals 3 and the magnetic core 1.

Further, the fourth adhesive part 54 is integrally connected with the bending leg 34, then the fourth adhesive part 54 is filled in the matching through hole 35, in which the filling height of the fourth adhesive part 54 in the matching through hole 35 can be more than one-third of the thickness of the metal terminals 3 to ensure the filling effect. The metal terminals 3 are fixed on the magnetic core 1 by matching the through hole 35 and the fourth adhesive part 54 to ensure the stability of the overall structure of the magnetic device.

It is understood that the first adhesive part 51, the second adhesive part 52, the third adhesive part 53, and the fourth adhesive part 54 all extend from the main colloidal part 50 under the structural design of the side board 12 and the magnetic cover 4. That is to ensure that the adhesive layer 5 as a whole, so that in the magnetic core 1, metal terminal 3 and magnetic cover 4 there is a good fixation effect between each two of them, so as to improve the overall structural reliability of magnetic device.

### Embodiment 5

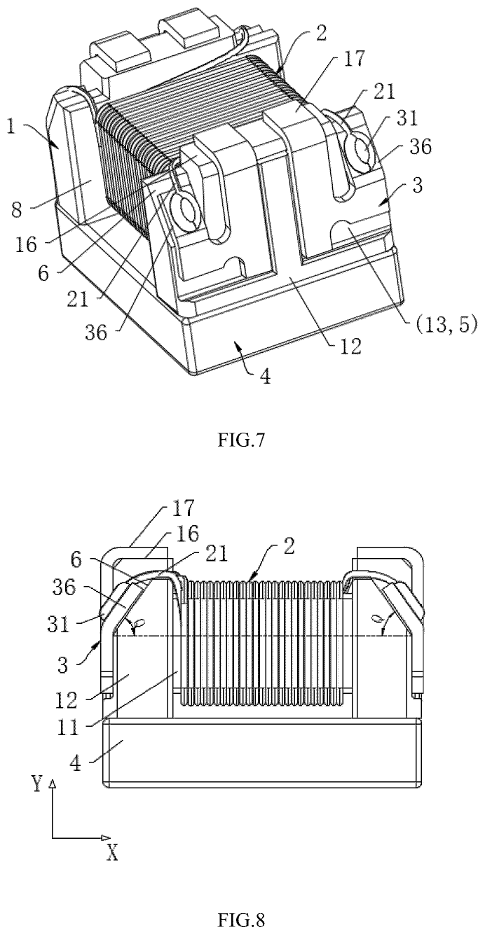

Referring to FIGS. 7 and 8, this embodiment adopts the same label as the above embodiments, and a difference between this embodiment and the above embodiments is that, the functional grooves 6 of this embodiment are disposed in one side of the side board 12 and the side board 12 has function inclined planes located at the functional grooves 6.

In the specific implementation process, taking the X-Y plane coordinates constructed in FIG. 8 as an example, the X-axis direction can be regarded as a first direction of the embodiment, and the Y-axis direction can be regarded as a second direction of the embodiment. Of course, the embodiment is not limited to this, and the X axis and Y axis can also be any other directions that are perpendicular to each other in the space according to actual installation requirements, which will not be repeated here.

Further, one side of each metal terminal 3 is connected with the functional leg 36, the welding part 31 is located on the functional leg 36 to form a terminal solder joint, the functional leg 36 is attached to the functional inclined plane, and the winding terminals 21 are corresponding to the functional legs 36 one by one and electrically connected with the welding parts 31 of the functional legs 36 through the functional inclined plane.

The functional inclined plane is inclined toward the middle column 11 and has a preset inclination angle with the first direction.

In this embodiment, each functional leg 36 is disposed on the corresponding functional inclined plane, that is, each functional leg 36 can be tilted from the second direction to the first direction, and each functional leg 36 is also tilted to the windings 2 and has the same preset inclination angle with the first direction as the corresponding functional inclined plane, so as to ensure the functional legs 36 to be tightly attached to the functional inclined plane.

Sides of the functional legs 36 facing to the functional inclined plane are flat, that is, the functional legs 36 and the functional inclined planes can be seamlessly attached together correspondingly.

It should be noted that, each functional inclined plane is inclined toward the middle column 11 and has the preset inclination angle with the first direction, and the winding terminals 21 are corresponding to the functional legs 36 one-by-one, each winding terminal 21 can be matched with one functional leg 36 at the same end. The function inclined plane is used to guide the outlet of the winding terminal 21 and provide a safe space for the corresponding winding terminal 21, so as to ensure the safe and firm electrical connection between the winding terminals 21 and the metal terminals 3, and then ensure the reliability of the magnetic device.

It should be noted that each functional groove 6 is defined on the side of the side board 12, or it can be understood that each functional inclined plane is disposed on the side of the side board 12 away from the windings 2 and the functional inclined plane is connected to one side of the side board 12, and the functional grooves 6 are communicated with the side board 12, so as to play the role of positioning groove to assemble the metal terminal 3 facilitately.

In this embodiment, due to the functional inclined planes 6, there is enough avoidance space between each functional inclined plane 6 and the side board 12, and when the winding terminals 21 are electrically connected with the functional leg 36, joints between the winding terminals 21 and the functional legs 36 are in the avoidance space that is, the joints will not affect a size of the magnetic device in a length direction. At the same time, it can also ensure that there is enough physical isolation space between the joints of winding terminals 21 and functional legs 36, and windings 2, so as to avoid the risk of melting and damage of winding terminal 2 due to high temperature when winding terminals 21 and functional legs 36 are welded and fixed. It can also prevent foreign body contamination to the windings 2 during welding, thus improving the structural reliability of magnetic device.

In this embodiment, the functional inclined planes are set to tilt toward the middle column 11 and has a preset inclination angle Q with the first direction, so that the value of Q is 5-80°, so as to ensure that each function inclined plane has enough avoidance space with respect to the side board 12, and the winding terminal 21 can be connected with the functional leg 36 along a tilt slope of the functional inclined plane, that helps to fix the winding terminal 21 and reduce its vibration or displacement.

In order to ensure that each functional inclined plane has enough space with respect to the side board 12, it is also possible to make the winding terminals 21 follow the tilt slope, and connect with the functional legs 36 closely, and the tilt slope of the functional inclined plane can be used to hide the joints between the winding terminals 21 and the functional legs 36. Q can be ranged from 20° to 70°, 30-60°, or 40-50°.

In some embodiments, each functional inclined plane is set to be inclined toward the middle column 11 and has a preset inclination angle with the first direction of Q, and Q is 45°.

In some embodiments, each functional inclined plane is set to be inclined toward the middle column 11 and has a preset inclination angle Q with the first direction, and Q is 10°.

In the specific implementation process, different from the first outer legs 32 of the aforementioned embodiment, each side board 12 is connected with a functional platform 16 on one side away from the magnetic cover 4, and the functional platform 16 protrudes from the corresponding functional inclined plane, and the side of each metal terminals 3 is connected with a second outer leg 17. The second outer leg 17 is clamped on the functional platform 16 and protrudes from the outer surface of the side board 12, so that the magnetic device can be externally connected by the second outer leg 17.

Further, the symmetrically arranged second outer legs 17 are maintained at a certain distance from each other, and the symmetrically arranged second outer legs 17 on the side board 12 on the same side are located between the symmetrically arranged functional grooves 6.

Each second outer leg 17 can be relatively perpendicularly extend from an end of the corresponding metal terminal 3, that is, each second outer leg 17 can maintain a 90° bending angle with the corresponding metal terminal 3, at the same time, the second outer legs 17 can also be parallel to the functional platform 16 on the side board 12, so as to facilitate the overall structure of the magnetic device is neat, and can also optimize the structure processing of magnetic device and improve the performance-price ratio of magnetic device.

In some embodiments, the second outer legs 17 may be relatively perpendicular to the second direction and parallel to the first direction.

It should be noted that, in this embodiment, there is a certain distance between the second outer legs 17 symmetrically arranged and the second outer leg 17 symmetrically arranged on the side board 12 on the same side is located between the functional grooves 6 symmetrically arranged, that is, when the magnetic device and the external object are connected through the second outer leg 17, the function inclined planes and the function platform 16 provide enough safety space for the wiring of the winding terminals 21, and can prevent the winding terminals 21 from contacting external system too much, thereby reducing the risk of accidentally scratching the winding terminals 21, so as to improve the operation safety of magnetic device.

In this embodiment, each welding part 31 is inclined toward the middle column 11 following the corresponding functional inclined plane. In detail, the winding terminals 21 are electrically connected to the functional legs 36 through the welding parts 31. The connection mode for the the winding terminals 21 and the functional legs 36 can be realized by welding, and the welding parts 31 can be an oblatinized sphere structure for convenient and fast welding.

In the specific implementation process, the groove wall surrounding each the first matching groove 13 are connected to the functional inclined plane, communicated with the functional groove, and the adhesive layers 5 in the first matching grooves 13 can also be extended to the functional inclined plane, so as to improve the fixed connection between the functional legs 36 and the side boards 12, and the winding terminals 21 and the side board s12, so as to ensure the structural reliability of the magnetic device as a whole. In the same way, the adhesive layers 5 can also be extended to the outer surface of the functional platform 16, thereby improving the fixed connection relationship between the second outer leg 17 and the side board 12.

That is, the functional inclined planes are symmetrically arranged on the side of the side board 12, each functional inclined plane is inclined toward the middle column 11 and has a preset inclination angle with the first direction, the functional legs 36 are configured to attach on the functional inclined planes correspondingly, and the winding terminals 21 are corresponding to the functional legs 36 one by one and electrically connected with the functional legs 36 through the functional inclined plane. In this way, the structural reliability of the magnetic device is improved and the comprehensive performance of magnetic device is optimized.

### Embodiment 6

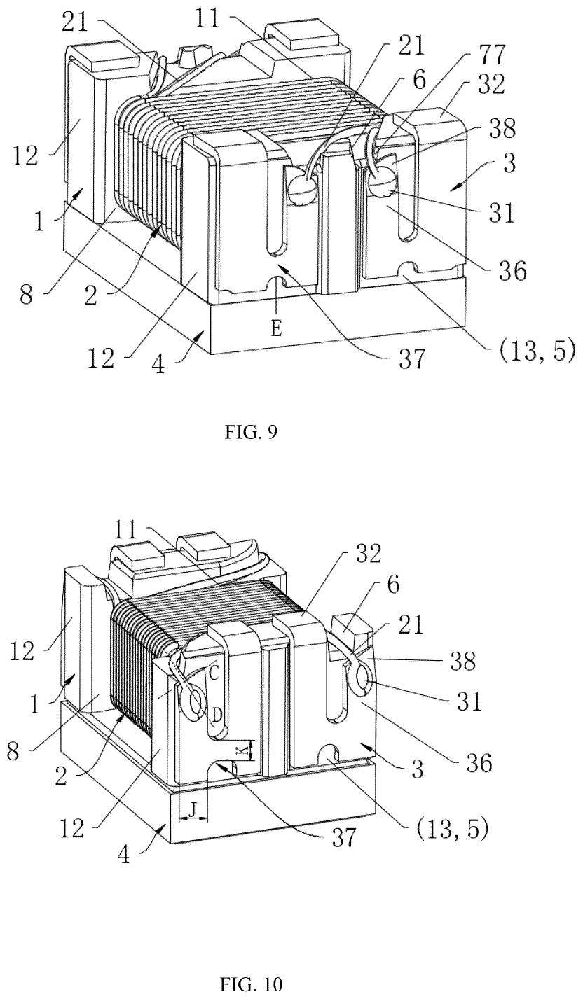

Referring to FIGS. 9 and 10, the embodiment is the same as the above embodiments, a difference of this embodiment and the above embodiments is that, the functional grooves 6 of the embodiment are arranged on the side board 12 of the same side, the metal terminals 3 are connected with a first outer legs 32, the first outer legs 32 are snapped on the side board 12 deviating from the magnetic cover 4 and protruding on the outer surface of the side board 12. And the functional grooves 6 can be arranged between the first outer legs 32, or the first outer legs 32 are arranged between the functional grooves 6.

In the specific implementation process, one side of each metal terminals 3 is connected with one functional leg 36, each functional leg 36 of the embodiment is located in the first matching groove 13, each welding part 31 is located on the functional leg 36 to form a terminal solder joint, and each welding part 31 and the corresponding winding terminal 21 are corresponding to the functional groove 6. That is, the winding terminals 21 are electrically connected with the welding parts 31 through the functional grooves 6, and the winding terminals 21 of each winding 2 can be matched with functional grooves 6 at the same end through the corresponding winding terminals 21 and functional grooves 6, so as to ensure that the outlet of winding terminals 21 is guided through the functional grooves 6 and a safe space is provided for each winding terminal 21.

It should be noted that the metal terminals 3 are located on the side of side board 12 away from the middle column 11, it can be ensure that sufficient physical isolation spaces between joints of the winding terminal 21 and metal terminal 3, and winding 2, As a result, it will avoid the risk of the melting windings 2 due to high temperature when the winding terminals 21 and the metal terminals 3 are welded and fixed. It can also prevent foreign body contamination to the winding 2 during welding, thus improving the structural reliability of the magnetic device.

In this embodiment, the groove depth of each functional groove 6 is greater than the wire diameter of the corresponding winding terminal 21, so that each functional groove 6 can better accommodate and guide the corresponding winding terminal 21, and the groove shapes of the functional grooves 6 can be shapes of arc, triangle, U-shape, trapezoidal or rectangular, so as to better guide the winding terminals 21 and ensure that the winding terminals 21 are attached correctly on the winding terminals 21. Additional mechanical stability may also be provided to help secure the winding terminals 21 and reduce vibration or displacement.

In the specific implementation process, the functional grooves 6 can be communicated with the first matching grooves 13. There is a chamfer portion between between each the functional groove 6 and the corresponding first matching groove 13 which can prevent the corresponding winding terminal 21 from being forced at the corner of the functional groove 6 and the first matching groove 13 to prevent the corresponding winding terminal 21 from damage. So that the winding terminals 21 can be smoothly connected with the welding parts 31 after being led out from the functional grooves 6, and the reliability of the product is improved.

The functional groove 6 can be gradually expanded toward the first matching groove 13, or it can be rectangular.

Furthermore, seventh auxiliary grooves 77 can be defined on the side of each side board 12 deviated from the middle column 11, and the seventh auxiliary grooves 77 are communicated with the functional grooves 6 and the first matching grooves 13 respectively, and each seventh auxiliary groove 77 is gradually expanded from the functional groove 6 to the first matching groove 13, that is, each seventh auxiliary groove 77 can be a flared shaped. So that the winding terminals 21 can be smoothly connected with the welding parts 31 after being led out of the functional grooves 6, avoiding excessive hard contact with the groove wall of the functional grooves 6, so as to ensure the quality of the winding terminal 21.

That is, one side of each side board 12 is connected with the metal terminals 3 away from the middle column 11, one side of each metal terminals 3 is connected with the corresponding functional leg 36, each welding part 31 is provided with the functional leg 36, each the side board 12 deviating from the magnetic cover 4 defines the corresponding functional groove 6, then the corresponding winding terminal 21 is electrically connected with the welding part 31 through the functional groove 6, thus, the outlet of the winding terminals 21 are guided through the functional grooves 6 and safe space is provided for the winding terminals 21, which ensures that there is enough physical isolation space between the joints of the winding terminal 21 and the metal terminals 3, and the winding 2, so as to improve the structural reliability of the magnetic device and optimize the comprehensive performance of the magnetic device.

### Embodiment 7

Referring to FIGS. 9 and 10, the embodiment adopts the same label as the above embodiment. A difference between this embodiment and above embodiments is that this embodiment one side of each metal terminal 3 provided with a functional leg 36, a welding part 31 is disposed on the corresponding functional leg 36, and a waist 37 is located between each functional leg 36 and the corresponding metal terminal 3. The two ends of each waist 37 are respectively connected with one functional leg 36 and one metal terminal 3, where the structural width of the waist 37 is the structural width of the functional leg 36 of a second multiple.

In the specific implementation process, each waist 37 is used as a link between the corresponding functional leg 36 and the metal terminal 3, that is, when the welding part 31 of the functional leg 36 and the winding terminal 21 are welded, the structural design of the waist 37 reduces the heat transmission from welding to the metal terminals 3.

Furthermore, setting the structural width of the functional leg 36 as J, and the structural width of the waist 37 as K, then K=2J.

The value range of the second multiple of the embodiment may range from 0.2 to 0.9, that is, the structural width of the waist 37 maybe 0.2 to 0.9 times the structural width of the functional leg 36.

In some other embodiments, the width of the waist 37 is 0.2 times, 0.4 times, 0.6 times, 0.7 times or 0.9 times the width of the functional leg 36.

Two side E of the waist 37 can be contracted face to face in the structure. Or one side E of the waist 37 is retracted toward the other side E opposite to the one side E.

In some other embodiments, a section of the side E can be in an arc shape, so that each the functional leg 36 and the corresponding metal terminal 3 are connected by a narrow bridge structure, so as to reduce the heat transfer from the welding part 31 to the metal terminal 3.

It can be understood that the structural width of the waist 37 in this embodiment is much smaller than the structural width of the functional leg 36, and the contour line of the side E can also be a regular straight line, which is not described here.

On the other hand, one side of each the metal terminal 3 in this embodiment is provided with a functional leg 36, one end of the functional leg 36 is provided with a chamfer portion 38, and the welding part 31 is located on the chamfer portion 38, which is laid on the functional leg 36 toward the corresponding functional groove 6 so that the corresponding welding part 31 is inclined toward the corresponding functional groove 6 After each the winding terminal 21 passes through the functional groove 6 to electrically connected to the corresponding welding part 31, there is an angle between the extension direction of the winding terminal 2 and an edge of the chamfer portion 38 towards the functional groove 6.

A value for the set-points angle ranges from 60° to 90°.

In detail, the value of the angle of the set point can be 60°, 70°, 80° or 90°. When the angle is 90°, an extension direction of the winding terminal 2 is perpendicular to the edge of the chamfer portion 38 towards the functional groove 6.

The extension direction of the winding terminal 2 is set as C, and the edge of the chamfer portion 38 towards the functional groove 6 is set as D. There is the angle between C and D, that is, under the action of the chamfer portion 38, the extension direction of the winding terminal 2 has an angle the edge of the chamfer portion 38 towards the functional groove 6, so as to prevent the winding terminals 21 from deviating from the welding positions, and also facilitate the electrical connection between the winding terminals 21 and the welding parts 31, and ensure that the winding terminals 21 and the welding parts 31 are firmly connected, and improve product reliability.

The above is a detailed introduction to the application. In this disclosure, a specific example is applied to explain the principle and implementation of the application. The above embodiment is only used to help understand the core idea of the Application. At the same time, for the technical personnel in this field, according to the idea of this application, there will be changes in the specific implementation and application scope. To sum up, the content of this specification should not be understood as a limitation of this application.

1. A magnetic device comprising:
a magnetic core, comprising:
a middle column, and side boards connected at two ends of the middle column, and each side board defining functional groove;
windings, winding on the middle column according to a preset rules, and both ends of each winding providing with winding terminals;
metal terminals, disposed on one side of each side boards away from the column at a certain interval, each two of the metal terminals at different side boards being respectively opposite to each other, the winding terminal electrically connected to a welding part of each metal terminal through the functional groove;
a magnetic cover, connected to the magnetic core and together with the magnetic core to form a closed magnetic circuit; and
adhesive layers, each adhesive layer being arranged between each two of the side boards, the metal terminals and the magnetic cover; and the magnetic cover and the metal terminals being bonded and fixed on the magnetic core.

2. The magnetic device of claim 1, wherein the side board defines first matching grooves, and the metal terminals are respectively matched in the first matching grooves through corresponding adhesive layers, and a groove depth of each first matching groove is larger than a thickness of one corresponding metal terminal of a first multiple.

3. The magnetic device of claim 1, wherein the functional grooves are located on one sides of the each side board away from the magnetic cover, and between two adjacent metal terminals.

4. The magnetic device of claim 2, wherein one side of the metal terminal is provided with a connecting leg toward the side board, and both sides of the side board away from the function groove define second matching grooves communicated with the first matching grooves correspondingly, and the connecting leg is fixed in the second matching groove through a corresponding adhesive layer.

5. The magnetic device of claim 1, wherein each metal terminal is connected with a first outer leg, and the first outer leg is snapped on one side of the side board away from the magnetic cover and protruding out of an outer surface of the side board.

6. The magnetic device of claim 5, wherein 0.1B≤A≤B; or, B<A≤B+1.5 mm, A indicates a shortest distance between one side of the welding part close to the first outer leg and one side of the first outer leg away from the welding part; B indicates a width of the first outer leg.

7. The magnetic device of claim 1, wherein first auxiliary grooves are defined on the both sides of the side board, second auxiliary grooves are defines on sides of the magnetic cover corresponding to the first auxiliary grooves, and the first auxiliary grooves are communicate with the second auxiliary grooves respectively, and the first auxiliary grooves and the second auxiliary grooves are filled with the adhesive layers correspondingly.

8. The magnetic device of claim 1, wherein a third auxiliary groove is defined on one side of the side board close to the magnetic cover, and the third auxiliary groove is located between two adjacent metal terminals, and a fourth auxiliary groove is defines on the magnetic cover and corresponding to the third auxiliary groove, and the third auxiliary groove is communicated with the fourth auxiliary groove, the third auxiliary groove and the fourth auxiliary groove are filled with the adhesive layer respectively.

9. The magnetic device of claim 2, wherein the functional grooves are defined on the both sides of the side board, and fifth auxiliary grooves are defined at one end of the magnetic cover and corresponding to the metal terminals, and the side board defines sixth auxiliary grooves, the first matching groove and the fifth auxiliary groove are communicated through the sixth auxiliary groove, the fifth auxiliary groove and the sixth auxiliary groove are filled with the adhesive layer respectively.

10. The magnetic device of claim 2, wherein third matching grooves are defined in the side board and located at the first matching grooves respectively, and a bending leg integrally extends from each metal terminal and each bending leg is inserted into one third matching groove and is fixed inside the third matching groove through the corresponding adhesive layer.

11. The magnetic device of claim 10, wherein each metal terminal defines a matching through hole, and the bending leg extend into the matching through hole or maintained at a certain distance with the matching through hole, and the adhesive layer extends to the matching through hole.

12. The magnetic device of claim 1, wherein each functional groove arranged on one side of the side board and the one side of the side board has a functional inclined plane at each functional groove, one side of the metal terminal is connected with a functional leg, the welding part is located on the functional leg correspondingly, and the functional leg is stuck on the functional inclined plane.

13. The magnetic device of claim 12, wherein the functional inclined plane is inclined toward the middle column and has a preset inclination angle with a first direction, and the winding terminals are corresponding to the functional legs one by one and electrically connected with the welding part on the functional leg through the functional inclined plane.

14. The magnetic device of claim 13, wherein one side of the side board away from the magnetic cover is connected with functional platforms, and each functional platform protrudes from the functional inclined plane, and each metal terminal is connected with a second outer leg, and the second outer leg is clamped on the functional platform and protruding from the outer surface of the side board.

15. The magnetic device of claim 14, wherein the second outer legs are symmetrically arranged on the side boards at a certain distance from each other, and the second outer legs on the same side board are located between the functional inclined planes arranged symmetrically.

16. The magnetic device of claim 2, wherein one side of each metal terminal is connected with a functional leg located in the first matching groove, and the welding part is located on the functional leg, and the welding part and the winding terminal are corresponding to the functional groove.

17. The magnetic device of claim 16, wherein the functional grooves and the first matching grooves are communicated, and there is a chamfer portion at a connection between one functional groove and on corresponding first matching groove.

18. The magnetic device of claim 1, wherein one side of the metal terminal is provided with a functional leg, and the welding part is located on the functional leg, and the functional leg and the metal terminal are provided with a waist, and the two ends of the waist are connected with the functional leg and the metal terminal respectively, a width of the waist is a width of the functional leg of a second multiple.

19. The magnetic device of claim 1, wherein one side of the metal terminal is provided with a functional leg, and one end of the functional leg is provided with a chamfer portion, and the welding part is located on the chamfer portion, and there is a setting angle between an extension direction of the winding terminal after electrically connected via the functional groove and one side of the chamfer portion towards the functional groove.

20. The magnetic device of claim 1, wherein the middle column and the side board are integrally connected to form an I-shape or a drum shape, and a part of the side board protruding from the middle column forms a leg wall, and a height of the leg wall relative to the middle column is greater than a height of the windings relative to the middle column.
